(19) United States
(12) Patent Application Publication
(10) Pub. No.: US 2020/0387489 A1
(43) Pub. Date: Dec. 10, 2020

(54) SYSTEMS AND METHODS FOR DATA STORAGE AND QUERYING

(71) Applicant: BEIJING DIDI INFINITY TECHNOLOGY AND DEVELOPMENT CO., LTD., Beijing (CN)

(72) Inventor: Zhen FANG, Hangzhou (CN)

(73) Assignee: BEIJING DIDI INFINITY TECHNOLOGY AND DEVELOPMENT CO., LTD., Beijing (CN)

(21) Appl. No.: 17/000,308

(22) Filed: Aug. 22, 2020

Related U.S. Application Data
(63) Continuation of application No. PCT/CN2019/075830, filed on Feb. 22, 2019.

(30) Foreign Application Priority Data
Feb. 22, 2018 (CN) 201810153900.8

(51) Int. Cl. G06F 16/22; G06F 16/2458

(52) U.S. Cl. CPC G06F 16/2246; G06F 16/2264; G06F 16/2462

(57) ABSTRACT

The present disclosure provides systems and method for data storage and querying. An embodiment of the methods may include: obtaining target data to be stored; generating statistical data by performing one or more statistical analyses on the target data according to one or more preset dimensions of the target data; and storing the statistical data associated with the target data. Therefore, when a user requests to query statistical indicators of data, the user can obtain the statistical indicators without traversing all the data, thereby improving the query speed and efficiency.

### CROSS-REFERENCE TO RELATED APPLICATIONS

This application is a Continuation of International Application No. PCT/CN2019/075830, filed on Feb. 22, 2019, which claims priority to Chinese Patent Application No. 201810153900.8, filed on Feb. 22, 2018, the contents of which are incorporated herein by reference.

### TECHNICAL FIELD

The present disclosure generally relates to computer technology, and in particular, to systems and methods for data storage and querying.

### BACKGROUND

With the continuous development and application of big data technology, statistics and management of data (e.g., data associated with travel services, data associated with delivery services, etc.) are becoming more and more important. Operators often need to analyze and display specific statistical indicators of the data based on map information. In related technologies, the collected data is generally directly stored. If a user desires to query and display specific statistical indicators, the user needs to traverse a large amount of data and perform statistical analyses to obtain the statistical indicators that are requested in the query. Accordingly, the query speed of statistical indicators of the data is slow, and the display efficiency is low.

Therefore, it is desirable to provide methods and systems for efficient data storage and querying to improve the query speed.

### STATEMENT OF INVENTION

1. A system for storing data, comprising:

at least one storage medium including a set of instructions; and

at least one processor in communication with the at least one storage medium, wherein when executing the set of instructions, the at least one processor is to cause the system to perform operations including:
obtaining target data to be stored;
generating statistical data by performing one or more statistical analyses on the target data according to one or more preset dimensions of the target data; and
storing the statistical data associated with the target data.
   2. The system of item 1, wherein the generating statistical data by performing statistical analysis on the target data according to one or more preset dimensions comprises:

determining target coordinates of the target data in the one or more preset dimensions;

identifying one or more coordinate intervals; and

for each coordinate interval of the one or more coordinate interval,
generating a parameter of the statistical data by performing the one or more statistical analyses on a portion of the target data that have target coordinates in the each coordinate interval, the parameter of the statistical data corresponding to the each coordinate interval.
   3. The system of item 2, wherein the storing the statistical data comprises:

storing the statistical data using a preset data structure.

4. The system of item 3, wherein the preset data structure includes a multi-branch tree.
5. The system of item 4, wherein the storing the statistical data using a preset data structure comprises:

generating one or more nodes of the multi-branch tree by constructing the multi-branch tree based on the one or more coordinate intervals;

determining a target node of the one or more nodes corresponding to the each parameter of statistical data, based on the each coordinate interval corresponding to the each parameter of statistical data; and

storing the each parameter of statistical data in the target node.

6. The system of any one of items 1-5, wherein the one or more preset dimensions include at least one of a time dimension, a space dimension, or a business dimension.
7. The system of any one of items 1-6, wherein the storing the statistical data comprises:

storing the statistical data into one or more internal memories and/or one or more external storages.

8. The system of item 3, wherein the preset data structure includes a data cube.
9. The system of item 8, wherein the at least one processor is configured to cause the system to perform additional operations including:

automatically adjusting one or more dimensions of the data cube.

10. The system of item 9, wherein the one or more dimensions of the data cube are adjusted based on at least one of

a size of one or more internal memories of the system,

a current transmission frequency of the target data transmitted to the system,

a current total amount of the target data,

a current amount of the target data in each of the one or more dimensions,

a current data access frequency,

a current data access quantity in the one or more dimensions,

a current size of the data cube,

a predicted transmission frequency of the target data transmitted to the system,

a predicted total amount of the target data,

a predicted amount of the target data in each of the one or more dimensions,

a predicted data access frequency,

a predicted data access quantity in the one or more dimensions, or

a predicted size of the data cube.

11. The system of item 9, wherein the automatically adjusting one or more dimensions of the data cube comprises:

automatically adjusting one or more hierarchies of the data cube, or one or more levels of the one or more hierarchies.

12. The system of item 9, wherein the automatically adjusting one or more dimensions of the data cube comprises:

performing a pruning operation on the data cube to remove a portion of the data organized in the data cube out of one or more internal memories of the system.

13. The system of any one of items 2-12, wherein the identifying one or more coordinate intervals comprises:

identifying one or more coordinate intervals based on one or more preset criteria.

14. The system of item 10, wherein the identifying one or more coordinate intervals comprises:

identifying one or more coordinate intervals based on at least one of
a current data access frequency,
a current data access quantity in the one or more dimensions,
a predicted data access frequency, or
a predicted data access quantity in the one or more dimensions.
   15. The system of item 1, wherein the storing the statistical data comprises:

generating a multi-branch tree including a plurality of nodes based on the one or more dimensions;

determining a correspondence between each node and a corresponding coordinate interval associated with the one or more dimensions; and

storing the statistical data according to the plurality of nodes.

### SUMMARY

According to one aspect of the present disclosure, a system for storing data is provided. The system may include at least one storage medium including a set of instructions; and at least one processor in communication with the at least one storage medium. When executing the set of instructions, the at least one processor may be configured to cause the system to perform operations including: obtaining target data to be stored; generating statistical data by performing one or more statistical analyses on the target data according to one or more preset dimensions of the target data; and/or storing the statistical data associated with the target data.

In some embodiments, the generating statistical data by performing statistical analysis on the target data according to one or more preset dimensions may include: determining target coordinates of the target data in the one or more preset dimensions; identifying one or more coordinate intervals; and/or for each coordinate interval of the one or more coordinate interval, generating a parameter of the statistical data by performing the one or more statistical analyses on a portion of the target data that have target coordinates in the each coordinate interval, the parameter of the statistical data corresponding to the each coordinate interval.

In some embodiments, the storing the statistical data may include storing the statistical data using a preset data structure.

In some embodiments, the preset data structure may include a multi-branch tree.

In some embodiments, the storing the statistical data using a preset data structure may include: generating one or more nodes of the multi-branch tree by constructing the multi-branch tree based on the one or more coordinate intervals; determining a target node of the one or more nodes corresponding to the each parameter of statistical data, based on the each coordinate interval corresponding to the each parameter of statistical data; and/or storing the each parameter of statistical data in the target node.

In some embodiments, the one or more preset dimensions may include at least one of a time dimension, a space dimension, and a business dimension.

In some embodiments, the storing the statistical data may include storing the statistical data into one or more internal memories and/or one or more external storages.

In some embodiments, the preset data structure may include a data cube.

In some embodiments, the at least one processor may be configured to cause the system to perform additional operations including automatically adjusting one or more dimensions of the data cube.

In some embodiments, the one or more dimensions of the data cube may be adjusted based on at least one of a size of one or more internal memories of the system, a current transmission frequency of the target data transmitted to the system, a current total amount of the target data, a current amount of the target data in each of the one or more dimensions, a current data access frequency, a current data access quantity in the one or more dimensions, a current size of the data cube, a predicted transmission frequency of the target data transmitted to the system, a predicted total amount of the target data, a predicted amount of the target data in each of the one or more dimensions, a predicted data access frequency, a predicted data access quantity in the one or more dimensions, and a predicted size of the data cube.

In some embodiments, the automatically adjusting one or more dimensions of the data cube may include automatically adjusting one or more hierarchies of the data cube, or one or more levels of the one or more hierarchies.

In some embodiments, the automatically adjusting one or more dimensions of the data cube may include performing a pruning operation on the data cube to remove a portion of the data organized in the data cube out of one or more internal memories of the system.

In some embodiments, the identifying one or more coordinate intervals may include identifying one or more coordinate intervals based on one or more preset criteria.

In some embodiments, the identifying one or more coordinate intervals may include identifying one or more coordinate intervals based on at least one of a current data access frequency, a current data access quantity in the one or more dimensions, a predicted data access frequency, and a predicted data access quantity in the one or more dimensions.

In some embodiments, the storing the statistical data may include: generating a multi-branch tree including a plurality of nodes based on the one or more dimensions; determining a correspondence between each node and a corresponding coordinate interval associated with the one or more dimensions; and/or storing the statistical data according to the plurality of nodes.

According to another aspect of the present disclosure, a system for querying data is provided. The system may include at least one storage medium including a set of instructions; and at least one processor in communication with the at least one storage medium. When executing the set of instructions, the at least one processor may be configured to cause the system to perform operations including: receiving a query request associated with one or more preset dimensions; determining, based on the query request, target data matching one or more query criteria associated with the query request; and/or providing the target data to a requester.

In some embodiments, the determining, based on the query request, target data matching one or more query criteria associated with the query request may include: identifying one or more target coordinate intervals in the one or more preset dimensions, the one or more target coordinate intervals being associated with the one or more query criteria; and/or determining data in the one or more target coordinate intervals as the target data.

In some embodiments, the providing the target data to a requester may include providing the target data to the requester according to a sequence associated with the one or more preset dimensions.

According to another aspect of the present disclosure, a method for storing data is provided. The method may be implemented on a computing device having one or more processors and one or more storage devices for storing data. The method may include: obtaining target data to be stored; generating statistical data by performing one or more statistical analyses on the target data according to one or more preset dimensions of the target data; and/or storing the statistical data associated with the target data.

According to another aspect of the present disclosure, a method for querying data is provided. The method may be implemented on a computing device having one or more processors and one or more storage devices for querying data. The method may include: receiving a query request associated with one or more preset dimensions; determining, based on the query request, target data matching one or more query criteria associated with the query request; and/or providing the target data to a requester.

According to another aspect of the present disclosure, a system for storing data is provided. The system may include an acquisition module configured to obtain target data to be stored; a generation module configured to generate statistical data by performing one or more statistical analyses on the target data according to one or more preset dimensions of the target data; and/or a storing module configured to store the statistical data associated with the target data.

According to another aspect of the present disclosure, a system for querying data is provided. The system may include an acquisition module configured to receive a query request associated with one or more preset dimensions; a determination module configured to determine, based on the query request, target data matching one or more query criteria associated with the query request; and/or a transmission module configured to provide the target data to a requester.

According to another aspect of the present disclosure, a non-transitory computer readable medium is provided. The non-transitory computer readable medium may include at least one set of instructions for storing data. When executed by one or more processors of a computing device, the at least one set of instructions may cause the computing device to perform a method including: obtaining target data to be stored; generating statistical data by performing one or more statistical analyses on the target data according to one or more preset dimensions of the target data; and/or storing the statistical data associated with the target data.

According to another aspect of the present disclosure, a non-transitory computer readable medium is provided. The non-transitory computer readable medium may include at least one set of instructions for querying data. When executed by one or more processors of a computing device, the at least one set of instructions may cause the computing device to perform a method including: receiving a query request associated with one or more preset dimensions; determining, based on the query request, target data matching one or more query criteria associated with the query request; and/or providing the target data to a requester.

The technical solutions provided by the embodiments of the present disclosure may have the following beneficial effects:

According to some systems and methods for data storage of the present disclosure, target data may be obtained, statistical analyses may be performed on the target data according to preset dimensions, and the statistical results associated with the target data may be stored. Therefore, when a user requests to query statistical indicators of data, the user can obtain the statistical indicators without traversing all the data, thereby improving the query speed and efficiency.

According to some systems and methods for data querying of the present disclosure, one or more query criteria associated with preset dimensions may be obtained, target data matching the one or more query criteria may be determined, and the query result may be output based on the matched target data. Thereby, the goal of quick querying of statistical indicators of data may be achieved without traversing all the pre-stored data, and the query speed and efficiency may be improved.

The above general descriptions and the following detailed descriptions are intended to be illustrative, and not intended to limit the present disclosure.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary data storage and/or querying system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device on which a terminal device may be implemented according to some embodiments of the present disclosure;

FIGS. 4A and 4B are block diagrams illustrating exemplary processing devices according to some embodiments of the present disclosure;

FIG. 5 is a flowchart illustrating an exemplary process for storing data according to some embodiments of the present disclosure;

FIG. 6 is a flowchart illustrating an exemplary process for storing data according to some embodiments of the present disclosure;

FIG. 7 is a flowchart illustrating an exemplary process for storing statistical data using a multi-branch tree according to some embodiments of the present disclosure;

FIG. 8 is a flowchart illustrating an exemplary process for storing data using a data cube according to some embodiments of the present disclosure;

FIG. 9 is a flowchart illustrating an exemplary process for querying data according to some embodiments of the present disclosure;

FIG. 10 is a schematic diagram illustrating an exemplary electronic device according to some embodiments of the present disclosure; and

FIG. 11 a schematic diagram illustrating another exemplary electronic device according to some embodiments of the present disclosure.

### DETAILED DESCRIPTION

Exemplary embodiments will be described in detail herein, and examples thereof are shown in the drawings. When the following description refers to the drawings, like reference numerals in different drawings represent the same or similar elements unless otherwise indicated. The embodiments described in the following “exemplary embodiments” do not represent all embodiments consistent with the present disclosure.

The terms used in the present disclosure are merely provided for the purpose of describing particular embodiments, and not intended to limit the present disclosure. The singular forms “a,” “an,” and “the” used in the present disclosure and the claims refer to include the plural forms as well, unless the context clearly indicates otherwise. It should also be understood that the term “and/or” used herein refers to and contains any or all of the possible combinations of one or more associated listed items.

It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

It should be understood that although the terms “first,” “second,” “third,” etc. may be used in the present disclosure to describe various forms of information, the information should not be limited to these terms. These terms may just be used to distinguish information of the same type from each other. For example, first information may also be referred to as second information, without departing from the scope of the present disclosure. Similarly, the second information may also be referred to as the first information. Depending on the context, the word “if” as used herein may be interpreted as “when” or “in response to a determination that.”

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding data storage and querying in a transportation system in land, it should be understood that this is only one exemplary embodiment. The systems and methods of the present disclosure may be applied to any other kind of transportation system or any other online to offline (O2O) service system. For example, the systems and methods of the present disclosure may be applied to transportation systems of different environments including ocean, aerospace, or the like, or any combination thereof. The vehicle of the transportation systems may include a car, a bus, a train, a subway, a vessel, an aircraft, a spaceship, a hot-air balloon, or the like, or any combination thereof.

An aspect of the present disclosure relates to systems and methods for data storage and querying. According to some systems and methods of the present disclosure, the systems and methods may obtain target data to be stored; generate statistical data by performing one or more statistical analyses on the target data according to one or more preset dimensions of the target data; and storing the statistical data associated with the target data (e.g., using a multi-branch tree). According to some systems and methods of the present disclosure, the systems and methods may receive a query request associated with one or more preset dimensions; determine, based on the query request, target data matching one or more query criteria associated with the query request; and provide the target data to a requester.

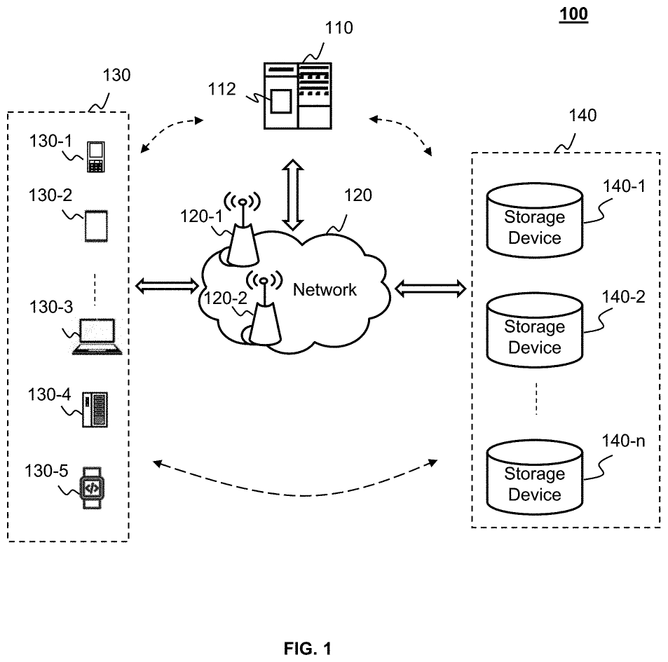

FIG. 1 is a schematic diagram illustrating an exemplary data storage and/or querying system according to some embodiments of the present disclosure. In some embodiments, the system 100 may be applied to one or more fields. Exemplary fields may include online to offline services or online on-demand services such as transportation services (associated with car-hailing, driver hiring, etc.), delivery services (associated with booking a meal, shopping, etc.), or any field in which data is continuously generated to be stored and further queried, or the like, or any combination thereof. In some embodiments, the system 100 may include a server 110, a network 120, one or more terminal devices 130, and one or more storage devices 140. The components in the system 100 may be connected in one or more of various ways. Merely by way of example, the storage device(s) 140 may be connected to the server 110 directly (as indicated by the bi-directional arrow in dotted lines linking the storage device 140 and the server 110) or through the network 120. As another example, the server 110 may be connected to the terminal device 130 directly (as indicated by the bi-directional arrow in dotted lines linking the server 110 and the terminal device 130) or through the network 120. As still another example, the terminal device 130 may be connected to the storage device 140 directly (as indicated by the bi-directional arrow in dotted lines linking the terminal device 130 and the storage device 140) or through the network 120.

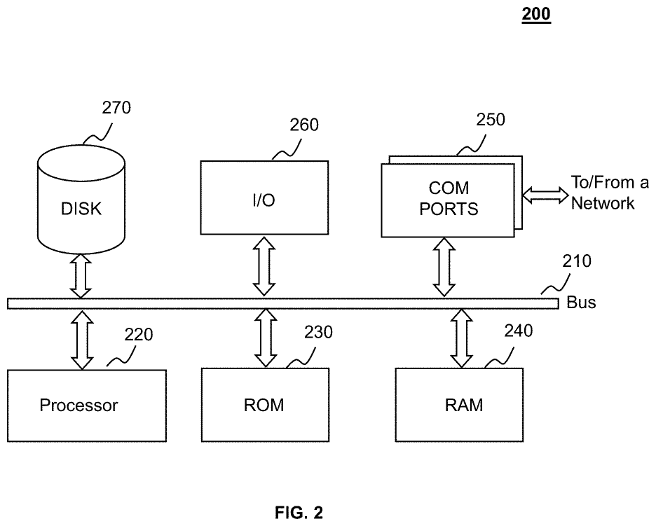

In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the terminal device 130 and/or the storage device 140 via the network 120. As another example, the server 110 may be directly connected to the terminal device 130 and/or the storage device 140 to access stored information and/or data. In some embodiments, the server 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 in the present disclosure.

In some embodiments, the server 110 may include at least one processing device 112. The processing device 112 may process information and/or data related to data storage and/or query to perform one or more functions described in the present disclosure. For example, the processing device 112 may obtain target data (e.g., data transmitted to the system 100) to be stored. As another example, the processing device 112 may generate statistical data by performing one or more statistical analyses on the target data according to one or more preset dimensions of the target data. As still another example, the processing device 112 may store the statistical data associated with the target data. As still another example, the processing device 112 may receive a query request associated with one or more preset dimensions. As still another example, the processing device 112 may determine, based on the query request, target data matching one or more query criteria associated with the query request. As still another example, the processing device 112 may provide the target data to a requester. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components (e.g., the server 110, the terminal device 130, or the storage device 140) of the system 100 may send information and/or data to other component(s) of the system 100 via the network 120. For example, the processing device 112 may obtain target data to be stored from the storage device 140 via the network 120. As another example, the processing device 112 may store statistical data associated with the target data to a storage device (e.g., the storage device 140) via the network 120. As still another example, the terminal device 130 may transmit a query request to the server 110 via the network 120. As still another example, the processing device 112 may receive the query request transmitted by the terminal device 130 via the network 120. As still another example, the processing device 112 may provide the target data associated with the query request to a requester via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points, through which one or more components of the system 100 may be connected to the network 120 to exchange data and/or information.

In some embodiments, the terminal device(s) 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift™, a HoloLens™, a Gear VR1υ, etc. In some embodiments, the built-in device in the vehicle 130-4 may include an onboard computer, an onboard television, etc. In some embodiments, the wearable device 130-5 may include a smart bracelet, a smart footgear, smart glasses, a smart helmet, a smart watch, smart clothing, a smart backpack, a smart accessory, or the like, or any combination thereof. In some embodiments, the server 110 may be integrated into or implemented on the terminal device(s) 130.

The terminal device(s) 130 may be configured to facilitate communications between a user (e.g., a requester) and the system 100. For example, the user may send a query request via the terminal device 130 to the system 100. As another example, the user may access data and/or information stored in one or more storage devices (e.g., the storage device 140) of the system 100 via the terminal device 130. In some embodiments, the terminal device(s) 130 may be configured to transmit target data to be stored to the system 100. For illustration, taking transportation services as an example, the target data may include order information associated with the transportation services. The order information may be generated continuously in a plurality of terminal device(s) 130 associated with the transportation services. The plurality of terminal devices may transmit the order information to the system 100 to be stored and/or further queried.

The storage device 140 may store data and/or instructions. In some embodiments, the storage device 140 may store data obtained from the terminal device 130, such as a query request or target data to be stored. In some embodiments, the storage device 140 may store data generated or processed by the server 110. For example, the server 110 may generate statistical data by performing one or more statistical analyses on the target data according to one or more preset dimensions of the target data, and the storage device 140 may store the statistical data. In some embodiments, the storage device 140 may store data and/or instructions that the server 110 may execute or use to perform exemplary methods described in the present disclosure.

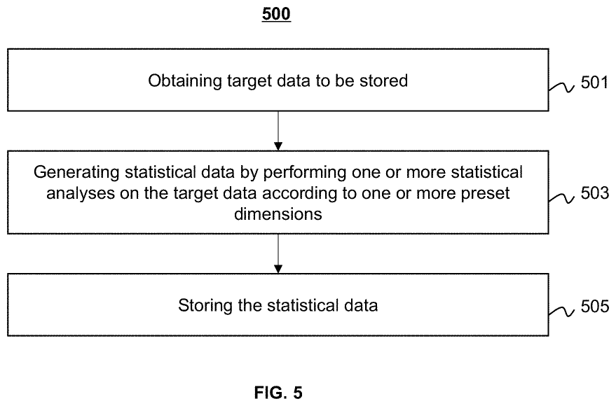

In some embodiments, the storage devices 140 may include one or more storage devices such as a storage device 140-1, a storage device 140-2, . . . , a storage device 140-n as shown in FIG. 1. The storage devices 140 may be configured to store data/information associated with the system 100, independently or jointly. Merely by way of example, the storage device 140-1 may store target data transmitted to the system 100 to be stored. In some embodiments, the target data (and/or the statistical data) may have one or more hot degrees. As another example, the storage device 140-2 may store statistical data with a relatively high hot degree, while the storage device 140-n may store statistical data with a relatively low hot degree. In some embodiments, statistical data with different hot degrees may be stored in different types of storage devices. For example, statistical data with a relatively high hot degree may be stored in an initial memory of the system 100, so that the statistical data with a relatively high hot degree can be accessed or downloaded quickly. As another example, statistical data with a relatively low hot degree may be stored in a hard disk. More descriptions of hot degrees of the target data may be found elsewhere in the present disclosure (e.g., FIG. 5 and descriptions thereof).

In some embodiments, the storage device 140 may be connected to the network 120 to communicate with one or more components (e.g., the server 110, terminal device 130) of the system 100. One or more components of the system 100 may access the data or instructions stored in the storage device 140 via the network 120. In some embodiments, the storage device 140 may be directly connected to or communicate with one or more components (e.g., the server 110, the terminal device 130) of the system 100. In some embodiments, at least a portion of the storage device(s) 140 may be part of the server 110. In some embodiments, at least a portion of the storage device(s) 140 may be integrated in the terminal device(s) 130. In some embodiments, at least a portion of the storage device(s) 140 may be set in one or more Internet Data Centers (IDCs). The IDC may refer to a data center established by a service provider or IDC company to provide stable and wide-band network services, high performance computing services, and/or hosting services.

In some embodiments, the data stored in the storage device 140 may be organized in a database (e.g., a distributed file sub-system), an information source, or the like, or any combination thereof. The database may facilitate the storage and retrieve of the data. The distributed file sub-system may include a Hadoop Distributed File System (HDFS), a Network File System (NFS), a KASS File System (KASS), an Andrew File System (AFS), or the like, or any combination thereof. Taking the HDFS as an example, initial data and/or preprocessed data may be stored in the HDFS for retrieving. The HDFS may communicate with one or more components (e.g., the server 110, the terminal device 130) of the system 100 via the network 120 or directly communicate with the one or more components (e.g., the server 110, the terminal device 130) of the system 100. In some embodiments, the database (e.g., a Hadoop Distributed File System (HDFS) may be a part of (or operated by) the storage device 140.

In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

It should be noted that the system 100 is merely provided for the purposes of illustration, and is not intended to limit the scope of the present disclosure. For persons having ordinary skills in the art, multiple variations or modifications may be made under the teachings of the present disclosure. However, those variations and modifications do not depart from the scope of the present disclosure. For example, the system 100 may be implemented on other devices to realize similar or different functions. As another example, the storage device 140 may be omitted from the system 100.

FIG. 2 is a schematic diagram illustrating exemplary hardware and/or software components of an exemplary computing device according to some embodiments of the present disclosure. In some embodiments, the server 110 may be implemented on the computing device 200. For example, the processing device 112 may be implemented on the computing device 200 and configured to perform functions of the processing device 112 disclosed in this disclosure.

The computing device 200 may be used to implement any component of the system 100 of the present disclosure. For example, the processing device 112 of the system 100 may be implemented on the computing device 200, via its hardware, software program, firmware, or a combination thereof. Although only one such computer is shown for convenience, the computer functions related to the system 100 as described herein may be implemented in a distributed manner on a number of similar platforms to distribute the processing load.

The computing device 200, for example, may include communication (COM) ports 250 connected to and from a network (e.g., the network 120) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read only memory (ROM) 230, or a random access memory (RAM) 240, for storing various data files to be processed and/or transmitted by the computing device 200. The computing device 200 may also include program instructions stored in the ROM 230, the RAM 240, and/or other type of non-transitory storage medium to be executed by the processor 220. The methods and/or processes of the present disclosure may be implemented as the program instructions. The computing device 200 may also include an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As in another example, operation A and operation B may also be performed by two different processors jointly or separately in the computing device 200 (e.g., the first processor executes operation A and the second processor executes operation B, or the first and second processors jointly execute operations A and B).

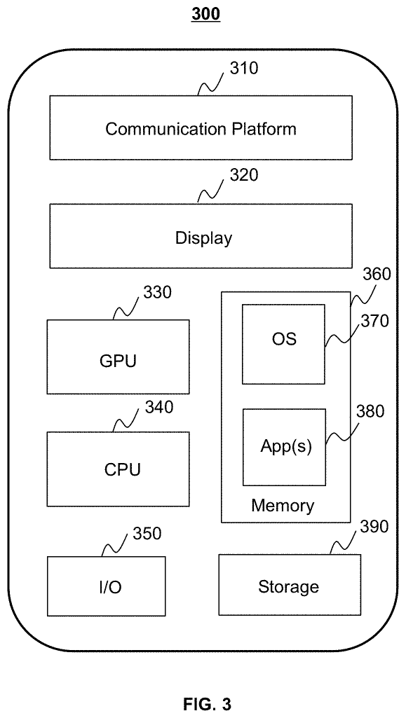

FIG. 3 is a schematic diagram illustrating exemplary hardware and/or software components of an exemplary mobile device on which a terminal device may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to positioning or other information from the processing device 112. User interactions with the information stream may be achieved via the I/O 350 and provided to the processing device 112 and/or other components of the system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

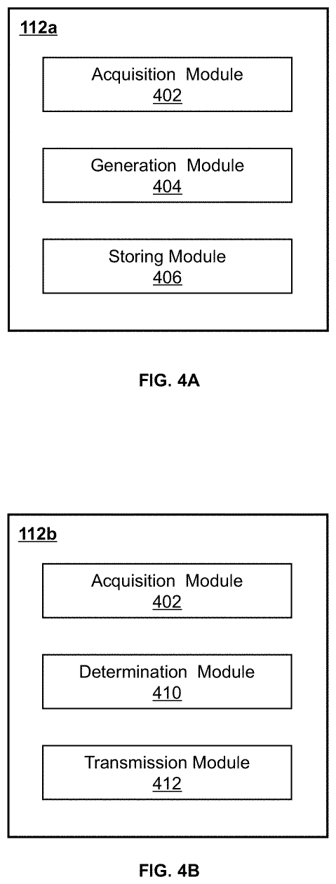

FIGS. 4A and 4B are block diagrams illustrating exemplary processing devices according to some embodiments of the present disclosure. In some embodiments, the processing devices 112a and 112b may be embodiments of the processing device 112 as described in connection with FIG. 1. In some embodiments, the processing device 112a may be configured to store data. The processing device 112b may be configured to query data. In some embodiments, the processing devices 112a and 112b may respectively be implemented on the computing device 200 (e.g., the processor 220) illustrated in FIG. 2 or the CPU 340 illustrated in FIG. 3. Merely by way of example, the processing device 112a may be implemented on the CPU 340 of a mobile device and the processing device 112b may be implemented on the computing device 200. Alternatively, the processing devices 112a and 112b may be implemented on the same computing device 200 or the same CPU 340.

FIG. 4A is a block diagram of an exemplary processing device for data storage (also referred to as data storage device) according to an embodiment of the present disclosure. As illustrated in FIG. 4A, the processing device 112a may include an acquisition module 402, a generation module 404, and a storing module 406.

The acquisition module 402 may be configured to acquire target data.

In some embodiment, the target data may be data associated with travel services that needs to be analyzed statistically (e.g., order data of vehicle services, etc.), data associated with delivery services that needs to be analyzed statistically (e.g., order data of the delivery services, etc.), etc. The present disclosure may not limit a specific content and type of the target data.

In some embodiments, the target data may be periodically acquired according to a preset period. The duration (or time length) of the preset period may be relatively short. For example, the duration of the preset period may be one hundredth of a second, one tenth of a second, one second, or the like. It should be understood that the present disclosure does not limit a specific duration of the preset period.

The generation module 404 may be configured to generate statistical data by performing one or more statistical analyses on the target data according to one or more preset dimensions of the target data.

In some embodiments, the one or more preset dimensions may be set in advance. The one or more preset dimensions may form a preset coordinate system. Coordinate(s) of the target data in the preset coordinate system may be calibrated. Specifically, in some embodiments, the one or more preset dimensions may include one or more of the following: a time dimension, a space dimension, a business dimension, or the like. Therefore, the target data may be calibrated from any one or more aspects of time, space, and business to obtain target coordinates corresponding to the target data in the preset coordinate system. For example, after the target data is obtained, the target coordinates corresponding to the target data in the preset coordinate system may be determined according to time information, space information, and business information of the target data.

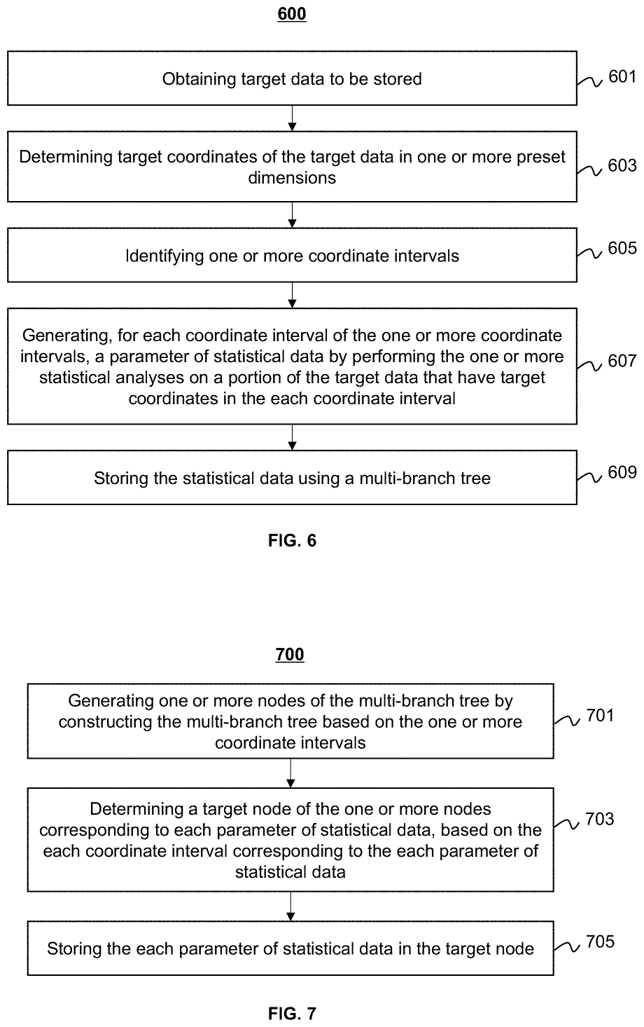

More descriptions of the preset dimensions may be found elsewhere in the present disclosure (e.g., FIG. 6 and descriptions thereof).

In some embodiments, one or more coordinate intervals may be identified. In some embodiments, each preset dimension may be divided into a plurality of unit cells in advance. In some embodiments, for the time dimension, a plurality of time unit cells may be obtained by time division according to a unit of 1 second. Alternatively, a plurality of time unit cells may be obtained by time division according to a unit of 1 minute, 1 hour, 1 day, 1 week, 1 month, 1 year, or the like. In some embodiments, for the space dimension, a map region may be divided into a plurality of unit cells with a honeycomb structure, and thus, the map region may include a plurality of adjacent hexagons with the same size. Each hexagon may be determined as a sub-region. One sub-region or multiple adjacent sub-regions may be designated as a space unit cell. In some embodiments, a plurality of space unit cells may be obtained by space division according to a unit of a business circle, an administrative region, a geographic area, or the like. In some embodiments, for the business dimension, businesses with the same type or the same characteristics may be designated as a business unit cell. The present disclosure may not limit the specific division manner of the unit cells. Then, in combination with the corresponding unit cells in each preset dimension, the one or more coordinate intervals may be obtained. Each coordinate interval may correspond to one or more unit cells in each preset dimension. For example, if the preset dimensions include the time dimension, the space dimension, and the business dimension, then each coordinate interval may correspond to one or more time unit cells, one or more space unit cells, and one or more business unit cells.

In some embodiments, according to the target coordinates of the target data, one or more statistical analyses may be performed on a portion of the target data that corresponds to each coordinate interval. A result obtained by the statistics may include statistical data corresponding to each coordinate interval. Specifically, in some embodiments, the one or more coordinate intervals corresponding to the target data may be identified according to the target coordinates of the target data. For each coordinate interval of the one or more coordinate intervals, a parameter of the statistical data may be generated by performing the one or more statistical analyses on a portion of the target data that have target coordinates in the each coordinate interval. The parameter of the statistical data may correspond to the each coordinate interval.

The storing module 406 may be configured to store the statistical data.

In some embodiments, the statistical data may be stored using a preset data structure. The preset data structure may include a multi-branch tree. For example, the preset data structure may be a data cube, or the like.

In some embodiments, one or more nodes of the multi-branch tree may be generated by constructing the multi-branch tree based on the one or more coordinate intervals. Each node may correspond to a coordinate interval. A target node of the one or more nodes corresponding to each parameter of the statistical data may be determined based on the coordinate interval corresponding to the each parameter of the statistical data, and the each parameter of the statistical data may be stored in the target node.

According to the data storage device of some embodiments of the present disclosure, target data may be obtained, statistical analyses may be performed on the target data according to preset dimensions, and the statistical results associated with the target data may be stored. Therefore, when a user requests to query statistical indicators of data, the user can obtain the statistical indicators without traversing all the data, thereby improving the query speed and efficiency.

In some embodiments, the generation unit 402 may include: a first determination unit, a second determination unit, and a statistical unit (not shown in FIG. 4A).

The first determination unit may be configured to determine target coordinates of the target data in the one or more preset dimensions.

The second determination unit may be configured to identify one or more coordinate intervals.

The statistical unit may be configured to generate, for each coordinate interval of the one or more coordinate intervals, a parameter of the statistical data by performing the one or more statistical analyses on a portion of the target data that have target coordinates in the each coordinate interval.

In some embodiments, the storing module 406 may include a storing unit (not shown in FIG. 4A).

In some embodiments, the storing unit may be configured to store the statistical data using a preset data structure.

In some embodiments, the preset data structure may include a multi-branch tree.

In some embodiments, the storing unit may be configured to: generate one or more nodes of the multi-branch tree by constructing the multi-branch tree based on the one or more coordinate intervals; determine a target node of the one or more nodes corresponding to the each parameter of the statistical data, based on the each coordinate interval corresponding to the each parameter of the statistical data; and store the each parameter of the statistical data in the target node.

In some embodiments, the preset dimensions may include at least one of a time dimension, a space dimension, and a business dimension.

It should be understood that the above device (i.e., the data storage device) may be preset in a server (e.g., the server 110), or may be loaded into the server by downloading. The corresponding modules and/or units in the device may cooperate with modules and/or units in the server to implement the data storage process.

FIG. 4B is a block diagram of an exemplary processing device for data querying (also referred to as data querying device) according to an embodiment of the present disclosure. As illustrated in FIG. 4B, the processing device 112b may include the acquisition module 402, a determination module 410, and a transmission module 412.

The acquisition module 402 may be configured to receive a query request associated with one or more preset dimensions.

In some embodiments, the preset dimensions may include one or more of the following: the time dimension, the space dimension, the business dimension, or the like. One or more query criteria of the query request may include query criteria for each preset dimension. For example, if the preset dimensions include the time dimension, the space dimension, and the business dimension, the query criteria may include query criteria for the time dimension, query criteria for the space dimension, and query criteria for the business dimension.

Taking vehicle services as an example, if the preset dimensions include the time dimension, the space dimension, and the business dimension, and the data is associated with the vehicle services, the query criteria may be the number or count of orders of express vehicles in the Chaoyang District on Dec. 31, 2016. In such situation, “on Dec. 31, 2016” may be a query criterion for the time dimension, “in the Chaoyang District” may be a query criterion for the space dimension, and “orders of express vehicles” may be a query criterion for the business dimension.

In some embodiments, each preset dimension may be divided into a plurality of unit cells. For example, for the time dimension, a plurality of time unit cells may be obtained by time division according to a unit of 1 second. Alternatively, a plurality of time unit cells may be obtained by time division according to a unit of 1 minute, 1 hour, 1 day, 1 week, 1 month, 1 year, or the like. For the space dimension, a map region may be divided into a plurality of unit cells with a honeycomb structure, and thus, the map region may include a plurality of adjacent hexagons with the same size. Each hexagon may be determined as a sub-region. One sub-region or multiple adjacent sub-regions may be designated as a space unit cell. A plurality of space unit cells may be obtained by space division according to a unit of a business circle, an administrative region, a geographic area, or the like. For the business dimension, businesses with the same type or the same characteristics may be designated as a business unit cell. The present disclosure may not limit the specific division manner of the unit cell.

The determination module 410 may be configured to determine, based on the query request, target data matching one or more query criteria associated with the query request.

In some embodiments, the target data matching one or more query criteria associated with the query request may be determined from pre-stored data based on the one or more query criteria. Specifically, in some embodiments, one or more target coordinate intervals in each preset dimension may be identified according to the query criteria, and data in the one or more target coordinate intervals may be determined from the pre-stored data and designated as the target data.

In some embodiments, the one or more target coordinate intervals may be associated with the one or more query criteria.

Taking vehicle services as an example, if the preset dimensions include the time dimension, the space dimension, and the business dimension, the pre-stored data is associated with the vehicle services, and the query criteria are the number or count of orders of express vehicles in the Chaoyang District on Dec. 31, 2016, then, for the time dimension, the target time coordinate interval may be a time interval of one day on Dec. 31, 2016. For the space dimension, the target space coordinate interval may be a region of a plurality of space unit cells covered by the Chaoyang District. For the business dimension, the business coordinate interval may be the businesses of all orders of express vehicles.

The transmission module 412 may be configured to output a query result.

The query result may include the target data. In some embodiments, the transmission module 412 may provide the target data to a requester.

In some embodiments, the query result may be output, based on the target data, to a display device having a display function for displaying the query result. Alternatively, the target data may be output to the display device according to a preset sequence associated with one or more preset dimensions (e.g., a specific preset dimension), enabling the display device to dynamically display the query result in a graph according to the specific preset dimension(s).

According to the data querying device of some embodiments of the present disclosure, one or more query criteria associated with preset dimensions may be obtained, target data matching the one or more query criteria may be determined, and the query result may be output based on the matched target data. Thereby, the goal of quick querying of statistical indicators of data may be achieved without traversing all the pre-stored data, and the query speed and efficiency may be improved.

In some embodiments, the determination module 410 may include an identification unit and a search unit (not shown in FIG. 4B).

The identification unit may be configured to identify one or more target coordinate intervals in the one or more preset dimensions, according to the query criteria.

The search unit may be configured to determine, from pre-stored data, data in the one or more target coordinate intervals, and designate the data as the target data.

In some embodiments, the transmission module 412 may include an output unit (not shown in FIG. 4B).

The output unit may be configured to output the target data to the display device according to a preset sequence associated with one or more specific preset dimensions.

It should be understood that the above device (i.e., the data querying device) may be preset in a server (e.g., the server 110), or may be loaded into the server by downloading. The corresponding modules and/or units in the device may cooperate with modules and/or units in the server to implement the data querying process.

The modules in the processing devices 112a and/or 112b may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. In some embodiments, two or more of the modules may be combined into a single module, and any one of the modules may be divided into two or more units or be omitted. In some embodiments, the processing devices 112a and 112b may be integrated as a single processing device.

FIG. 5 is a flowchart illustrating an exemplary process for storing data according to some embodiments of the present disclosure. The process 500 may be executed by the system 100. For example, the process 500 may be implemented as a set of instructions stored in the storage ROM 230 or RAM 240. The processor 220 and/or the modules in FIGS. 4A and/or 4B may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process 500 illustrated in FIG. 5 and described below is not intended to be limiting.

The process 500 may be performed on the server 110. As illustrated in FIG. 5, the process 500 may include the following operations:

In 501, target data may be obtained.

In some embodiments, the target data may be data to be stored. In some embodiments, the processing device 112a (e.g., the acquisition module 402) may perform operation 501.

In some embodiments, the target data may be data associated with travel services that needs to be analyzed statistically (e.g., order data of vehicle services, etc.), data associated with delivery services that needs to be analyzed statistically (e.g., order data of the delivery services, etc.), etc. The present disclosure may not limit a specific content and type of the target data.

In some embodiments, the target data to be stored may include a part or all of data transmitted to the system 100. In some embodiments, the data transmitted to the system 100 may include a plurality of data sets with different hot degrees. As used herein, a hot degree may indicate an importance or request frequency of data. For example, if a data set has a relatively high hot degree, the frequency in which the data set is requested or the importance of the data set may be relatively high. In some embodiments, the processing device 112a may determine data sets that have hot degrees larger than a preset hot degree as the target data for further processing (e.g., storing). In some embodiments, the hot degrees may include top hot, medium hot, non-hot, etc. The hot degrees may be set by an operator or a default setting of the system 100, and/or may be adjustable in different situations. For example, a data set may be determined to have a relatively high hot degree in a first situation (e.g., a default setting of the system), and to have a relatively low hot degree in a second situation (e.g., with low or zero request frequency of the data set in a time period).

Taking travel services as an example, the target data may be operation data associated with a plurality of orders generated during the travel services. Exemplary operation data may include time information, space information, business information, user information, or the like, or any combination thereof orders associated with the travel services. The time information may include time that an order of the travel service is requested, initiated time (e.g., pick-up time) of the order, completed time (e.g., arrival time) of the order, or the like, or any combination thereof. The space information may include a start location (e.g., pick-up location) of an order of the travel service, a destination of the order, route information of the order, or the like, or any combination thereof. The business information may include a taxi-hailing service, a chauffeur service, an express car service, a carpool service, a bus service, a driver hire service, a shuttle service, etc. The user information may include profile information (e.g., a gender, an age, contact information, a telephone number, an education level, an address, an occupation, a marriage state, a criminal record, a credit record, a traffic violation record, etc.) of a user associated with an order of the travel service (e.g., a service requester or a service provider), historical records of the user associated with historical orders of the travel service (e.g., a count of the historical orders), etc.

In some embodiments, the target data may be periodically acquired according to a preset period. The duration (or time length) of the preset period may be relatively short. For example, the duration of the preset period may be one hundredth of a second, one tenth of a second, one second, or the like. It should be understood that the present disclosure does not limit a specific duration of the preset period.

In some embodiments, the duration (or time length) of the preset period may be relatively long. For example, the duration of the preset period may be one minute, ten minutes, half of one hour, one hour, or the like.

In some embodiments, the target data may be stored in one or more storage devices of the system 100 after the target data is transmitted to the system 100. In some embodiments, the processing device 112a may obtain the target data directly (e.g., via a data cable) or via the network 120 from one or more storage devices of the system 100 (such as the storage device 140, the ROM 230, and/or the RAM 240). Additionally or alternatively, the processing device 112a may obtain the target data via the network 120 from an external source.

In 503, one or more statistical analyses may be performed on the target data according to one or more preset dimensions.

In some embodiments, the processing device 112a (e.g., the generation module 404) may generate statistical data by performing one or more statistical analyses on the target data according to the one or more preset dimensions. As used herein, a preset dimension may indicate a specific viewpoint for data analysis. Exemplary preset dimensions may include a time dimension, a space dimension, a business dimension, or the like, or any combination thereof. For example, if a user desires to know how data changes over time, the user may observe the data from the time dimension. As another example, if a user desires to know differences of data in different regions, the user may observe the data from the space dimension. More descriptions of the preset dimensions may be found elsewhere in the present disclosure (FIGS. 4 and 6 and descriptions thereof).

In some embodiments, the one or more statistical analyses may include determining a sum of at least a portion of the target data, an average of at least a portion of the target data, a maximum of at least a portion of the target data, a minimum of at least a portion of the target data, or the like, or any combination thereof. Taking vehicle services as an example, the target data may include operation data associated with a plurality of orders generated during the travel services, and the one or more preset dimensions may include the time dimension, the space dimension, and the business dimension. The processing device 112a may perform a summing-up analysis on a part or all of the operation data according to the time dimension, the space dimension, and/or the business dimension. For example, the processing device 112a may determine a specific indicator (e.g., a count of orders, a count of online users) associated with a particular time (e.g., November 30), space (e.g., the Chaoyang District) and/or business (e.g., chauffeur service) by performing a summing-up on a portion of operation data that corresponding to the particular time, space and/or business. In some embodiments, the processing device 112a may designate the specific indicator as a parameter of the statistical data. Therefore, the statistical data may include a plurality of parameters. In some embodiments, operation 503 may be performed according to operations 603-607 in FIG. 6. More descriptions of the generation of the statistical data may be found elsewhere in the present disclosure (e.g., operations 603-607 in FIG. 6 and the descriptions thereof).

In 505, statistical results may be stored.

In some embodiments, the processing device 112a (e.g., the storing module 406) may store the statistical data in one or more storage devices (e.g., the storage device(s) 140) of the system 100.

In some embodiments, the statistical data may be stored using a preset data structure. The preset data structure may include a multi-branch tree. For example, the preset data structure may be a data cube, or the like.

In some embodiments, the preset data structure may facilitate the organization of the statistical data in a form of multiple dimensions. If the statistical data is stored using the preset data structure, the stored statistical data may be queried or retrieved faster than data stored in a form of one dimension.

In some embodiments, the multi-branch tree may include a plurality of nodes. Each of the plurality of nodes may be configured to store a parameter of the statistical data. More descriptions of storing the statistical data using a multi-branch tree may be found elsewhere in the present disclosure (e.g., FIGS. 6-8 and the descriptions thereof).

In some embodiments, the processing device 112a may determine a hot degree of the statistical data before storing the statistical data. As used herein, a hot degree of the statistical data may indicate an importance or request (or query) frequency of the statistical data. For example, if a parameter of the statistical data has a relatively high hot degree, the frequency in which the parameter is requested (or queried) or the importance of the parameter may be relatively high. In some embodiments, the hot degrees of the statistical data may be set by an operator or a default setting of the system 100, and/or may be adjustable in different situations. In some embodiments, the processing device 112a may store a portion of the statistical data that has a relatively high hot degree in a first storage device (e.g., one or more internal memories) of the system 100. In some embodiments, the processing device 112a may store another portion of the statistical data that has a relatively low hot degree in a second storage device (e.g., one or more hard disks) of the system 100 or one or more external storages.

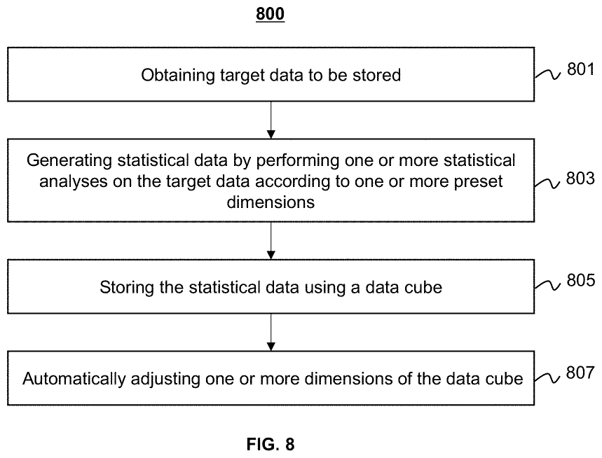

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added or omitted elsewhere in the process 500. For example, an operation for automatically adjusting the stored statistical data may be added after operation 503, e.g., eliminating a portion of the stored statistical data that has a relatively low hot degree from the stored statistical data. More descriptions of the optional operations may be found elsewhere in the present disclosure (e.g., FIG. 8 and descriptions thereof).

FIG. 6 is a flowchart illustrating an exemplary process for storing data according to some embodiments of the present disclosure. The process 600 may be executed by the system 100. For example, the process 600 may be implemented as a set of instructions stored in the storage ROM 230 or RAM 240. The processor 220 and/or the modules in FIGS. 4A and/or 4B may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIG. 6 and described below is not intended to be limiting.

FIG. 6 illustrates another embodiment of an exemplary data storage process. The process 600 may illustrate the process of the statistical analyses performed on the target data according to one or more preset dimensions. The process 600 may be performed on the server 110. As illustrated in FIG. 6, the process 600 may include the following operations:

In 601, target data may be obtained.

In some embodiments, the processing device 112a (e.g., the acquisition module 402) may obtain the target data to be stored. The target data to be stored may include a part or all of data transmitted to the system 100. More descriptions of the target data may be found elsewhere in the present disclosure (e.g., operation 501 in FIG. 5 and the descriptions thereof).

In 603, target coordinates of the target data in one or more preset dimensions may be determined.

In some embodiments, the processing device 112a (e.g., the generation module 404) may perform operation 603.

In some embodiments, the one or more preset dimensions may be set in advance. The one or more preset dimensions may form a preset coordinate system. Coordinate(s) of the target data in the preset coordinate system may be calibrated. Specifically, in some embodiments, the one or more preset dimensions may include one or more of the following: a time dimension, a space dimension, a business dimension, or the like. Therefore, the target data may be calibrated from any one or more aspects of time, space, and business to obtain target coordinates corresponding to the target data in the preset coordinate system. For example, after the target data is obtained, the target coordinates corresponding to the target data in the preset coordinate system may be determined according to time information, space information, and business information of the target data.

Merely by way of example, if the one or more preset dimensions include the time dimension, the space dimension and the business dimension, the preset coordinate system may correspond to a three-dimensional system. Each dimension of the time dimension, the space dimension, and the business dimension may correspond to an axis of the three-dimensional system.

In 605, one or more coordinate intervals may be identified.

In some embodiments, the processing device 112a (e.g., the generation module 404) may perform operation 605.

In some embodiments, each preset dimension may be divided into a plurality of unit cells in advance. In some embodiments, for the time dimension, a plurality of time unit cells may be obtained by time division according to a unit of 1 second. Alternatively, a plurality of time unit cells may be obtained by time division according to a unit of 1 minute, 1 hour, 1 day, 1 week, 1 month, 1 quarter, 1 year, or the like. In some embodiments, for the space dimension, a map region may be divided into a plurality of unit cells with a honeycomb structure, and thus, the map region may include a plurality of adjacent hexagons with the same size. Each hexagon may be determined as a sub-region. One sub-region or multiple adjacent sub-regions (e.g., five adjacent sub-regions, ten adjacent sub-regions) may be designated as a space unit cell. In some embodiments, a plurality of space unit cells may be obtained by space division according to a unit of a business circle, an administrative region (e.g., a district), a geographic area, or the like. In some embodiments, for the business dimension, businesses with the same type or the same characteristics may be designated as a business unit cell. The present disclosure may not limit the specific division manner of the unit cells. Then, in combination with the corresponding unit cells in each preset dimension, the one or more coordinate intervals may be obtained. Each coordinate interval may correspond to one or more unit cells in each preset dimension. For example, if the preset dimensions include the time dimension, the space dimension, and the business dimension, then each coordinate interval may correspond to one or more time unit cells, one or more space unit cells, and one or more business unit cells.

In some embodiments, the preset dimensions may include a user dimension. The user dimension may be associated with user information including a gender, an age, an occupation, an education level, an address, a marriage state, a criminal record, a credit record, a traffic violation record, or the like, or any combination thereof. Merely by way of example, for a user dimension associated with the gender, the coordinate interval may include a male, a female, etc. For a user dimension associated with the age, the coordinate interval may include 0-10 years old, 10-20 years old, or the like. For a user dimension associated with an occupation, the coordinate interval may include full-time drivers, part-time drivers, or the like. For a user dimension associated with the education level, the coordinate interval may include a high school diploma, a bachelor degree, a graduate degree, or the like.

In some embodiments, the processing device 112a may identify the one or more coordinate intervals based on one or more criteria. For example, the criteria may include artificial rules (e.g., the number and/or sizes of unit cells in each preset dimension). As another example, the criteria may be associated with a current data access frequency, a current data access quantity in the one or more dimensions, a predicted data access frequency, a predicted data access quantity in the one or more dimensions, or the like, or any combination thereof. In some embodiments, the processing device 112a may dynamically adjust the number and/or sizes of the coordinate intervals based on the criteria.

In 607, one or more statistical analyses may be performed on a portion of the target data that have target coordinates in each coordinate interval.

In some embodiments, the processing device 112a (e.g., the generation module 404) may generate, for each coordinate interval of the one or more coordinate interval, a parameter of statistical data by performing the one or more statistical analyses on a portion of the target data that have target coordinates in the each coordinate interval.

In some embodiments, according to the target coordinates of the target data, one or more statistical analyses may be performed on a portion of the target data that corresponds to each coordinate interval. A result obtained by the statistics may include statistical data corresponding to each coordinate interval. Specifically, in some embodiments, the one or more coordinate intervals corresponding to the target data may be identified according to the target coordinates of the target data. For each coordinate interval of the one or more coordinate intervals, a parameter of the statistical data may be generated by performing the one or more statistical analyses on a portion of the target data that have target coordinates in the each coordinate interval. The parameter of the statistical data may correspond to the each coordinate interval.

Taking vehicle services as an example, a time unit cell may be a day, a space unit cell may be a district of a city (e.g., the Chaoyang district, the Haidian District, the Dongcheng District, the Fengtai District, etc.), and a business unit cell may be a business with the same type (e.g., a chauffeur service, an express car service, a carpool service, etc.). Merely by way of example, a specific coordinate interval may correspond to seven consecutive days (e.g., from November 1 to November 7 in 2018), two districts (e.g., the Chaoyang district and the Haidian District), and the chauffeur service. The processing device 112a may determine a specific indicator (e.g., a count of orders) of the chauffeur service in the Chaoyang district and the Haidian District from November 1 to November 7 in 2018 as a parameter of the statistical data for the specific coordinate interval.

In 609, statistical results may be stored using a multi-branch tree.

In some embodiments, the processing device 112a (e.g., the storing module 406) may the store the statistical data using a multi-branch tree.

In some embodiments, one or more nodes of the multi-branch tree may be generated by constructing the multi-branch tree based on the one or more coordinate intervals. Each node may correspond to a coordinate interval. A target node of the one or more nodes corresponding to each parameter of the statistical data may be determined based on the each coordinate interval corresponding to the each parameter of the statistical data, and the each parameter of the statistical data may be stored in the target node.

In some embodiments, the processing device 112a may generate a multi-branch tree including a plurality of nodes based on the one or more dimensions. In some embodiments, the processing device 112a may determine a correspondence between each node and a corresponding coordinate interval associated with the one or more dimensions. In some embodiments, the processing device 112a may store the statistical data according to the plurality of nodes. More descriptions of storing the statistical data using a multi-branch tree may be found elsewhere in the present disclosure (e.g., FIGS. 7 and 8 and the descriptions thereof).

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added elsewhere in the process 600. For example, an operation for determining a hot degree of the statistical data may be added after operation 607. As another example, an operation for automatically adjusting the stored statistical data may be added after operation 609, e.g., eliminating a portion of the stored statistical data that has a relatively low hot degree from the stored statistical data.

According to the data storage process of some embodiments of the present disclosure, target data may be obtained; target coordinates of the target data may be determined in one or more preset dimensions; one or more coordinate intervals may be identified; for each coordinate interval, a parameter of statistical data may be generated by performing one or more statistical analyses on a portion of the target data that have target coordinates in the each coordinate interval; and the statistical data may be stored using a multi-branch tree. Therefore, when a user requests to query statistical indicators of data, the user can obtain the statistical indicators without traversing all the data. Besides, the statistical data is stored using a multi-branch tree, thereby improving the query speed and efficiency.

FIG. 7 is a flowchart illustrating an exemplary process for storing statistical data using a multi-branch tree according to some embodiments of the present disclosure. The process 700 may be executed by the system 100. For example, the process 700 may be implemented as a set of instructions stored in the storage ROM 230 or RAM 240. The processor 220 and/or the modules in FIGS. 4A and/or 4B may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 illustrated in FIG. 7 and described below is not intended to be limiting. In some embodiments, operations 609 illustrated in FIG. 6 may be performed according to the process 700.

In 701, the processing device 112a (e.g., the storing module 406) may generate one or more nodes of the multi-branch tree by constructing the multi-branch tree based on the one or more coordinate intervals.

In some embodiments, the processing device 112a may determine the nodes of the multi-branch tree based on the one or more coordinate intervals. Each of the nodes may correspond to a coordinate interval of the one or more coordinate intervals. For example, a first node may correspond to a coordinate interval of seven consecutive days from November 1 to November 7 in 2018, two districts of the Chaoyang district and the Haidian District, and the chauffeur service. As another example, a second node may correspond to a coordinate interval of seven consecutive days from November 1 to November 7 in 2018, two districts of the Chaoyang district and the Haidian District, and the express vehicle service. As still another example, a third node may correspond to a coordinate interval of seven consecutive days from November 8 to November 14 in 2018, two districts of the Chaoyang district and the Haidian District, and the chauffeur service.

In some embodiments, the processing device 112a may construct the multi-branch tree based on one or more dimensions associated with the one or more coordinate intervals. Each dimension may include a plurality of members, and each member may correspond to a node of the multi-branch tree. For example, the processing device 112a may construct one or more first branches of the multi-branch tree based on the time dimension and/or the space dimension. The processing device 112a may construct one or more second branches of the multi-branch tree based on the business dimension. Exemplary members of the time dimension may include a first quarter, a second quarter, a third quarter, and a fourth quarter. A member of the time dimension may correspond to one or more unit cells of the time dimension. As illustrated above, a specific coordinate interval may correspond to or include the one or more unit cells. Accordingly, a node of the multi-branch tree may correspond to the specific coordinate interval.

In 703, the processing device 112a (e.g., the storing module 406) may determine a target node of the one or more nodes corresponding to each parameter of statistical data, based on the each coordinate interval corresponding to the each parameter of statistical data.

In some embodiments, a specific parameter of statistical data may correspond to a specific coordinate interval. The processing device 112a may designate a node that is generated based on the specific coordinate interval as a target node corresponding to the specific parameter of statistical data.

In 705, the processing device 112a (e.g., the storing module 406) may store the each parameter of statistical data in the target node.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more additional operations may be added or omitted in process 700.

FIG. 8 is a flowchart illustrating an exemplary process for storing data using a data cube according to some embodiments of the present disclosure. The process 800 may be executed by the system 100. For example, the process 800 may be implemented as a set of instructions stored in the storage ROM 230 or RAM 240. The processor 220 and/or the modules in FIGS. 4A and/or 4B may execute the set of instructions, and when executing the instructions, the processor 220 and/or the modules may be configured to perform the process 800. The operations of the illustrated process presented below are intended to be illustrative. In some embodiments, the process 800 may be accomplished with one or more additional operations not described and/or without one or more of the operations discussed. Additionally, the order in which the operations of the process 800 illustrated in FIG. 8 and described below is not intended to be limiting.

In 801, the processing device 112a (e.g., the acquisition module 402) may obtain target data to be stored. Operation 801 may be the same as or similar to operation 501 as described in FIG. 5.

In 803, the processing device 112a (e.g., the generation module 404) may generate statistical data by performing one or more statistical analyses on the target data according to one or more preset dimensions. Operation 803 may be the same as or similar to operation 503 as described in FIG. 5 and/or operations 603-607 as described in FIG. 6.

In 805, the processing device 112a (e.g., the storing module 406) may store the statistical data using a data cube.

The data cube may be a multi-dimensional (e.g., 2-dimensional, 3-dimensional, or higher-dimensional) data structure. Each of the dimensions of the data cube may denote the target data from a specific viewpoint. As used herein, the dimensions may be similar to the preset dimensions described in operation 503 in FIG. 5. In some embodiments, each dimension of the data cube may include one or more hierarchies. Each hierarchy may include one or more levels. Each level may include one or more members. Merely by way of example, the time dimension may include one or more hierarchies such as “year, month, day,” and “year, quarter, month,” etc. A hierarchy of “year, quarter, month” may include levels of “year,” “quarter,” and “month.” A level of “quarter” may include members of “the first quarter,” “the second quarter,” “the third quarter,” and “the fourth quarter.” In some embodiments, the one or more levels of each hierarchy may construct a tree structure (also referred to as a hierarchy tree). A total of all members in a level of a hierarchy tree may be designated as a root node of the hierarchy tree. For example, for a time dimension from 2006-2015, a first level of “year” may include ten members of 2006, 2007, . . . , 2015. In a second level, each year may include four members corresponding to four quarters. In a third level, each quarter may include three members corresponding to three months of the each quarter. A root node of a hierarchy tree for the time dimension from 2006-2015 may include only one member corresponding to a total of all the members of the first level.

In some embodiments, the data cube may include a plurality of cells. Each cell may represent a measure of interest (e.g., an indicator) of the target data. As used herein, a cell may be similar to a node of a multi-branch tree as described in FIGS. 6-7. Taking vehicle services as an example, the target data may include operation data such as counts of orders (also referred to as order counts) associated with different types of vehicle services in different regions in different time periods. The data cube herein may be 3-dimensional. Accordingly, each cell of the data cube may represent a statistical value (e.g., a parameter of the statistical data) obtained according to a portion of the target data corresponding to a type of the vehicle services (e.g., express car service), a specific region, and a specific time period.

In some embodiments, the processing device 112a may determine the plurality of cells of the data cube based on the one or more coordinate intervals that are identified in the generation of the statistical data (e.g., as described in operation 605 in FIG. 6). Each cell of the data cube may correspond to a coordinate interval. That is, each cell may correspond to one or more dimensions associated with the coordinate intervals. The processing device 112a may determine a target cell of the plurality of cells corresponding to each parameter of statistical data based on the each coordinate interval corresponding to the each parameter of statistical data, which is similar to the determination of the target node as described in FIG. 7. The processing device 112a may then store the each parameter of statistical data in the target cell.

In 807, the processing device 112a (e.g., the storing module 406) may automatically adjust one or more dimensions of the data cube.

In some embodiments, the one or more dimensions of the data cube may be adjusted based on one or more criteria or rules. Exemplary criteria or rules may include a size of one or more internal memories of the system 100 (e.g., the storage device 140), real time status(es) (e.g., a current transmission frequency of the target data transmitted to the system 100, a current total amount of the target data, a current amount of the target data in each of the one or more dimensions, a current data access frequency, a current data access quantity in the one or more dimensions, or a current size of the data cube, etc.), predicted status(es) (e.g., a predicted transmission frequency of the target data transmitted to the system 100, a predicted total amount of the target data, a predicted amount of the target data in each of the one or more dimensions, a predicted data access frequency, a predicted data access quantity in the one or more dimensions, or a predicted size of the data cube). In some embodiments, the data cube may have a limited size. In some embodiments, the limited size of the data cube may relate to the size of one or more internal memories of the system 100. In some embodiments, if the current size of the data cube is approximately equal to the limited size, the processing device 112a may automatically adjust one or more dimensions of the data cube to improve available space of the data cube (e.g., by reducing the number of cells in the data cube, by reducing one or more dimensions of the data cube). In some embodiments, if a predicted amount of the target data in a specific dimension is larger than a preset amount (e.g., an amount that the data cube may accommodate in the specific dimension), the processing device 112a may automatically adjust the specific dimension of the data cube (e.g., by reducing one or more hierarchies of the specific dimension).

In some embodiments, the processing device 112a may automatically adjust one or more hierarchies of the data cube, or one or more levels of the one or more hierarchies to adjust the one or more dimensions of the data cube. Taking travel services as an example, the data cube may have four dimensions including a space dimension, a time dimension, a business dimension, and a user dimension (e.g., male, or female). An indicator of the data stored in the data cube may be a count of orders of male users or a count of online male users associated with express vehicles during ten minutes in one kilometer around a location (e.g., a region centered at the location with a radius of one kilometer). If there is no access of the count of orders of male users or the count of online male users, the processing device 112a may remove the level of male of the user dimension, or remove the hierarchy of “male, female” of the user dimension from the data cube, i.e., removing the user dimension. The data cube may include three dimensions after removing the user dimension. Accordingly, the indicator of the data stored in the data cube may be rolled up to be a count of orders or a count of online users associated with express vehicles during ten minutes in one kilometer around a location. In some embodiments, the processing device 112a may automatically add one or more hierarchies of the data cube, or one or more levels of the one or more hierarchies according to the one or more criteria or rules illustrated above.

In some embodiments, the processing device 112a may perform a pruning operation on the data cube to remove a portion of the data organized in the data cube out of one or more internal memories of the system 100 (e.g., the storage device 140-2). In some embodiments, the pruning operation may be performed to remove redundant data from the data cube to keep the data cube in a proper size. For example, the processing device 112a may determine hot degrees of the data organized in the data cube periodically or in real-time. In response to a determination that one or more hot degrees of the data is lower than a predetermined hot degree (also referred to as relatively low hot degree), the processing device 112a may remove corresponding data that has the relatively low hot degree from the data cube. The removed data may be removed out of the one or more internal memories (e.g., the storage device 140-2) that the data cube is stored. In some embodiments, the removed data may be transmitted to be stored in other storage devices (e.g., the storage device 140-1 (e.g., a hard disk), the storage device 140-n) directly or may be deleted directly. In some embodiments, the removed data may be compressed before transmission. In some embodiments, the removed data may be stored in another data cube configured in the other storage devices. In some embodiments, the hot degrees may be determined based on one or more criteria or rules such as a size of one or more internal memories of the system 100, the real time status(es) or the predicted status(es) as described elsewhere in the present disclosure. Merely by way of example, if a portion of the data in the data cube is not accessed in a predetermined time period, the portion of the data may be determined to have a relatively low hot degree, and may be removed from the data cube. Taking travel services as an example, data associated with travel services in midnight may have a relatively low hot degree in comparison with data associated with travel services in rush hours. In some embodiments, using automatic adjustment of the one or more dimensions of the data cube, the resources of one or more internal memories of the system 100 may be saved. Because relatively high hot data is stored in the one or more internal memories, users can query and/or download the relatively high hot data with improved speed and efficiency.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more additional operations may be added or omitted in process 800.

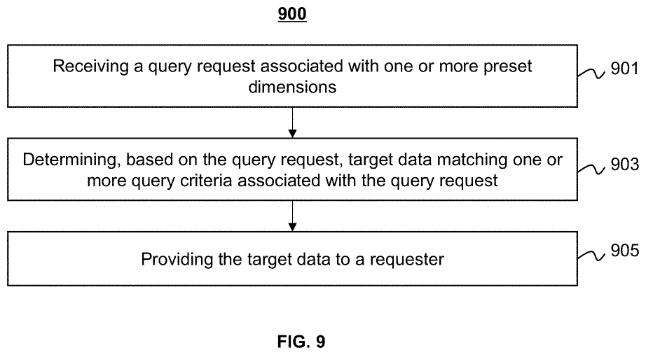

FIG. 9 is a flowchart illustrating an exemplary process for querying data according to some embodiments of the present disclosure. The process 900 may be executed by the system 100. For example, the process 900 may be implemented as a set of instructions stored in the storage ROM 230 or RAM 240. The processor 220 and/or the modules in FIGS. 4A and/or 4B may execute the set of instructions, and when executing the instructions, the processor 220 and/or the modules may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process 900 illustrated in FIG. 9 and described below is not intended to be limiting.

FIG. 9 illustrates an embodiment of an exemplary data querying process. The process 900 may be performed on the server 110. As illustrated in FIG. 9, the process 900 may include the following operations:

In 901, a query request associated with one or more preset dimensions may be received.

In some embodiments, the processing device 112b (e.g., the acquisition module 402) may receive the query request associated with one or more preset dimensions. In some embodiments, the query request may be associated with one or more query criteria.

In some embodiments, the one or more preset dimensions may include one or more of the following: a time dimension, a space dimension, a business dimension, or the like. The one or more query criteria may include query criteria for each preset dimension. For example, if the one or more preset dimensions include the time dimension, the space dimension and the business dimension, the one or more query criteria may include query criteria for the time dimension, query criteria for the space dimension, and query criteria for the business dimension.

Taking vehicle services as an example, if the preset dimensions include the time dimension, the space dimension, and the business dimension, and the data is associated with the vehicle services, then the query criteria may be the count (or number) of orders of express vehicles in the Chaoyang District on Dec. 31, 2016. In such situation, “on Dec. 31, 2016” may be a query criterion for the time dimension, “in the Chaoyang District” may be a query criterion for the space dimension, and “orders of express vehicles” may be a query criterion for the business dimension.

In some embodiments, each preset dimension may be divided into a plurality of unit cells. In some embodiments, for the time dimension, a plurality of time unit cells may be obtained by time division according to a unit of 1 second. Alternatively, a plurality of time unit cells may be obtained by time division according to a unit of 1 minute, 1 hour, 1 day, 1 week, 1 month, 1 year, or the like. In some embodiments, for the space dimension, a map region may be divided into a plurality of unit cells with a honeycomb structure, and thus, the map region may include a plurality of adjacent hexagons with the same size. Each hexagon may be determined as a sub-region. One sub-region or multiple adjacent sub-regions may be designated as a space unit cell. In some embodiments, a plurality of space unit cells may be obtained by space division according to a unit of a business circle, an administrative region, a geographic area, or the like. In some embodiments, for the business dimension, businesses with the same type or the same characteristics may be designated as a business unit cell. The present disclosure may not limit the specific division manner of the unit cells.

More descriptions of dividing the preset dimensions may be found elsewhere in the present disclosure (e.g., FIGS. 5-6 and the descriptions thereof).

In some embodiments, the processing device 112b may receive the query request from a terminal device (e.g., the terminal device 130) of the system 100 via the network 120. For example, a requester associated with the terminal device 130 may input or select the one or more query criteria in an application installed on the terminal device 130 to initiate the query request. The terminal device 130 may send the query request to the processing device 112b. In some embodiments, the user may initiate the query request via a typing interface, a hand gesturing interface, a voice interface, a picture interface, etc.

In 903, target data matching one or more query criteria associated with the query request may be determined based on the query request.

In some embodiments, the processing device 112b (e.g., the determination module 410) may perform operation 903.

In some embodiments, the target data matching one or more query criteria associated with the query request may be determined from pre-stored data based on the one or more query criteria. Specifically, in some embodiments, one or more target coordinate intervals in the one or more preset dimensions may be identified based on the query criteria, and data in the one or more target coordinate intervals may be determined from the pre-stored data and designated as the target data.

In some embodiments, the one or more target coordinate intervals may be associated with the one or more query criteria.

Taking vehicle services as an example, if the preset dimensions include the time dimension, the space dimension, and the business dimension, the pre-stored data is associated with the vehicle services, and the query criteria are the number or count of orders of express vehicles in the Chaoyang District on December 31, 2016, then, for the time dimension, the target time coordinate interval may be a time interval of one day on December 31, 2016. For the space dimension, the target space coordinate interval may be a region of a plurality of space unit cells covered by the Chaoyang District. For the business dimension, the business coordinate interval may be the businesses of all orders of express vehicles.

In some embodiments, the pre-stored data may include target data to be stored and/or statistical data that is stored as described elsewhere in the present disclosure (e.g., FIGS. 5-8 and the descriptions thereof). For example, the processing device 112b may determine whether a hot degree of the target data is lower than a preset threshold based on the one or more query criteria. The processing device 112b may determine a storage path of the target data based on the hot degree. In response to a determination that a hot degree of the target data is lower than a preset threshold, the processing device 112b may obtain the target data from a first storage device (e.g., the storage device 140-1 (e.g., a hard disk), the storage device 140-n) that stores non-hot data. Alternatively, in response to a determination that a hot degree of the target data is equal to or higher than a preset threshold, the processing device 112b may obtain the target data from a second storage device (e.g., the storage device 140-2 (e.g., an internal memory)) that stores hot data. In some embodiments, the preset threshold may be set by an operator of the system 100, and/or may be adjustable in different situations.

In 905, a query result may be output according to the target data.

In some embodiments, the processing device 112b (e.g., the transmission module 412) may provide the target data to a requester.

In some embodiments, the query result may be output, based on the target data, to a display device (e.g., the terminal device 130) having a display function for displaying the query result. Alternatively, the target data may be output to the display device according to a preset sequence associated with one or more preset dimensions (e.g., a specific preset dimension), enabling the display device to dynamically display the query result on a graph according to the specific preset dimension(s).

Therefore, the target data may be provided to the requester via the display device (e.g., the terminal device 130). In some embodiments, the requester may review the target data or perform further operations on the target data (e.g., downloading the target data, analyzing the target data).

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more additional operations may be added or omitted in the process 900. For example, after operation 905, the requester may send a feedback associated with a satisfactory of the query result, which may further used for improving the performance of the system 100.

According to the data querying process of some embodiments of the present disclosure, one or more query criteria associated with preset dimensions may be obtained, target data matching the one or more query criteria may be determined, and the query result may be output based on the matched target data. Thereby, the goal of quick querying of statistical indicators of data may be achieved without traversing all the pre-stored data, and the query speed and efficiency may be improved.

The embodiments of the devices may substantially correspond to the embodiments of the methods, and thus descriptions of the embodiments of the devices may refer to related partial descriptions of the embodiments of the methods. The embodiments of the devices described above are merely illustrative, wherein the units described as separated units may be or not be physically separated, and the units as displayed may be or not be physical units, i.e., may be located in one place, or be distributed in multiple network units. A part or all of the modules may be selected according to actual needs to achieve the objectives of the present disclosure. A person with ordinary skill in the art may understand and carry out the embodiments without paying creative work.

The embodiments of the present disclosure may take a form of a computer program product that is implemented on one or more storage medium (including but not limited to, disk storage, CD-ROM, optical memory) containing program code therein.

Correspondingly, the present disclosure provides a computer readable storage medium according to some embodiments. The computer readable storage medium may store a computer program, which can be used to execute the data storage method provided by any of the embodiments described in FIGS. 5-8.

Correspondingly, the present disclosure provides a computer readable storage medium according to some embodiments. The computer readable storage medium may store a computer program, which can be used to execute the data querying method provided by any of the embodiments described in FIG. 9.

The computer readable storage medium may be a computer readable storage medium included in the devices described in above embodiments, or a computer readable storage medium that exists alone and not assembled into a terminal or server. The computer readable storage medium may store one or more programs. The one or more programs may be used by one or more processors to perform data storage and/or querying method described in the present disclosure.

The computer-usable storage (e.g., the computer readable storage) medium may include permanent and/or non-permanent, removable and/or non-removable media, and may implement information storage by any method or technology. The information may be a computer readable instruction, a data structure, and a module of a program, or other data. Exemplary computer storage media may include but not limited to: a Phase-Change Random Access Memory (PRAM), a Static Random Access Memory (SRAM), a Dynamic Random Access Memory (DRAM), other types of Random Access Memory (RAM), a Read Only Memory (ROM), an Electrically Erasable Programmable Read-Only Memory (EEPROM), a flash memory or other memory technology, a Compact Disc-Read Only Memory (CD-ROM), a Digital Versatile Disc (DVD) or other optical storage, a cassette magnetic tape, a magnetic tape, a magnetic disk storage or other magnetic storage devices, or any other non-transmission media, that may be used for storing information that can be accessed by a computing device.

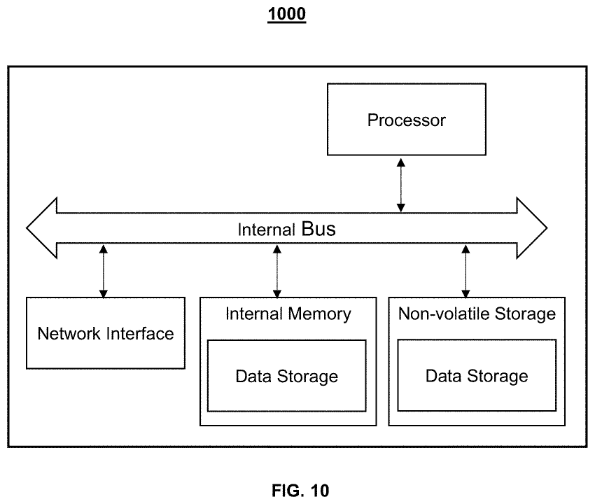

Corresponding to the above data storage method (as illustrated in FIGS. 5-8), the present disclosure provides a schematic diagram illustrating an exemplary electronic device 1000 according to some embodiments of the present disclosure as shown in FIG. 10. With reference to FIG. 10, hardware of the electronic device may include a processor, an internal bus, a network interface, an internal memory, and a non-volatile storage, and may of course include other hardware that are needed for other services. The processor may read corresponding computer programs from the non-volatile storage into the internal memory, and then runs the corresponding computer programs, forming a data storage device in the logical level. Of course, except for the software implementation, the present disclosure may not exclude other implementations, such as logic devices or a combination of hardware and software. In other words, an execution subject of the processing process as follows may not be limited to each logic unit, but may also be hardware or logic devices.

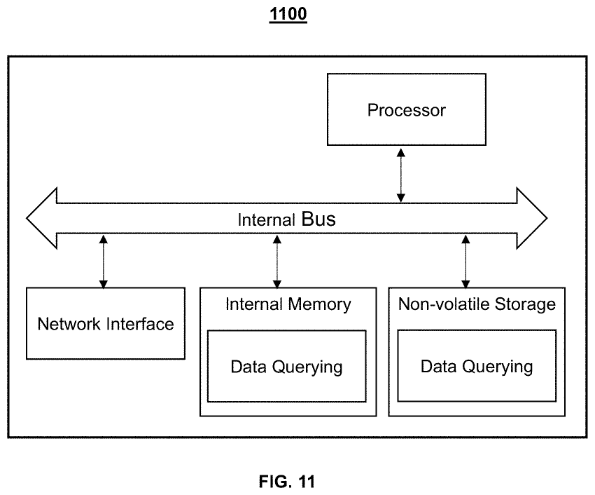

Corresponding to the above data querying method (as illustrated in FIG. 9), the present disclosure provides a schematic diagram illustrating an exemplary electronic device 1100 according to some embodiments of the present disclosure as shown in FIG. 11. With reference to FIG. 11, hardware of the electronic device may include a processor, an internal bus, a network interface, an internal memory, and a non-volatile storage, and may of course include other hardware that are needed for other services. The processor may read corresponding computer programs from the non-volatile storage into the internal memory, and then runs the corresponding computer programs, forming a data querying device on the logical level. Of course, except for the software implementation, the present disclosure may not exclude other implementations, such as logic devices or a combination of hardware and software. In other words, an execution subject of the processing process as follows may not be limited to each logic unit, but may also be hardware or logic devices.

Other embodiments of the present disclosure will be readily apparent to those skilled in the art, after they consider the specification and practice disclosed in the present disclosure herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments may be regarded as illustration only.

It should be understood that the present disclosure is not limited to the precise structures that have been described above and illustrated in the drawings, and modifications and variations may be made without departing from the scope thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for storing data, comprising:
at least one storage medium including a set of instructions; and
at least one processor in communication with the at least one storage medium, wherein when executing the set of instructions, the at least one processor is configured to cause the system to perform operations including:
obtaining target data to be stored;
generating statistical data by performing one or more statistical analyses on the target data according to one or more preset dimensions of the target data; and
storing the statistical data associated with the target data.

2. The system of claim 1, wherein the generating statistical data by performing one or more statistical analyses on the target data according to one or more preset dimensions comprises:
determining target coordinates of the target data in the one or more preset dimensions;
identifying one or more coordinate intervals; and
for each coordinate interval of the one or more coordinate interval, generating a parameter of the statistical data by performing the one or more statistical analyses on a portion of the target data that have target coordinates in the each coordinate interval, the parameter of the statistical data corresponding to the each coordinate interval.

3. The system of claim 2, wherein the storing the statistical data comprises:
storing the statistical data using a preset data structure.

4. The system of claim 3, wherein the preset data structure includes a multi-branch tree.

5. The system of claim 4, wherein the storing the statistical data using a preset data structure comprises:
generating one or more nodes of the multi-branch tree by constructing the multi-branch tree based on the one or more coordinate intervals;
determining a target node of the one or more nodes corresponding to the parameter of the statistical data corresponding to the each coordinate interval based on the each coordinate interval; and
storing the parameter of the statistical data in the target node.

6. The system of claim 1, wherein the one or more preset dimensions include at least one of a time dimension, a space dimension, or a business dimension.

7. The system of claim 1, wherein the storing the statistical data comprises:
storing the statistical data into at least one of one or more internal memories or one or more external storages.

8. The system of claim 3, wherein the preset data structure includes a data cube.

9. The system of claim 8, wherein the at least one processor is configured to cause the system to perform additional operations including:
automatically adjusting one or more dimensions of the data cube.

10. The system of claim 9, wherein the one or more dimensions of the data cube are adjusted based on at least one of
a size of one or more internal memories of the system,
a current transmission frequency of the target data transmitted to the system,
a current total amount of the target data,
a current amount of the target data in each of the one or more dimensions,
a current data access frequency,
a current data access quantity in the one or more dimensions,
a current size of the data cube,
a predicted transmission frequency of the target data transmitted to the system,
a predicted total amount of the target data,
a predicted amount of the target data in each of the one or more dimensions,
a predicted data access frequency,
a predicted data access quantity in the one or more dimensions, or
a predicted size of the data cube.

11. The system of claim 9, wherein the automatically adjusting one or more dimensions of the data cube comprises:
automatically adjusting one or more hierarchies of the data cube, or one or more levels of the one or more hierarchies.

12. The system of claim 9, wherein the automatically adjusting one or more dimensions of the data cube comprises:
performing a pruning operation on the data cube to remove a portion of the data organized in the data cube out of one or more internal memories of the system.

13. The system of claim 2, wherein the identifying one or more coordinate intervals comprises:
identifying the one or more coordinate intervals based on one or more preset criteria.

14. The system of claim 10, wherein the identifying one or more coordinate intervals comprises:
identifying the one or more coordinate intervals based on at least one of the current data access frequency,
the current data access quantity in the one or more dimensions,
the predicted data access frequency, or
the predicted data access quantity in the one or more dimensions.

15. The system of claim 2, wherein the storing the statistical data comprises:
generating a multi-branch tree including a plurality of nodes based on one or more dimensions associated with the one or more coordinate intervals;
determining a correspondence between each node and a corresponding coordinate interval associated with the one or more dimensions; and
storing the statistical data according to the plurality of nodes.

16. A system for querying data, comprising:
at least one storage medium including a set of instructions; and
at least one processor in communication with the at least one storage medium, wherein when executing the set of instructions, the at least one processor is configured to cause the system to perform operations including:
receiving a query request associated with one or more preset dimensions;
determining, based on the query request, target data matching one or more query criteria associated with the query request; and
providing the target data to a requester.

17. The system of claim 16, wherein the determining, based on the query request, target data matching one or more query criteria associated with the query request comprises:
identifying one or more target coordinate intervals in the one or more preset dimensions, the one or more target coordinate intervals being associated with the one or more query criteria; and
determining data in the one or more target coordinate intervals as the target data.

18. The system of claim 16, wherein the providing the target data to a requester comprises:
providing the target data to the requester according to a sequence associated with the one or more preset dimensions.

19. A method implemented on a computing device having one or more processors and one or more storage devices for storing data, the method comprising:
obtaining target data to be stored;
generating statistical data by performing one or more statistical analyses on the target data according to one or more preset dimensions of the target data; and
storing the statistical data associated with the target data.

20-24. (canceled)

25. The system of claim 19, wherein the generating statistical data by performing one or more statistical analyses-on the target data according to one or more preset dimensions comprises:
determining target coordinates of the target data in the one or more preset dimensions;
identifying one or more coordinate intervals; and
for each coordinate interval of the one or more coordinate interval,
generating a parameter of the statistical data by performing the one or more statistical analyses on a portion of the target data that have target coordinates in the each coordinate interval, the parameter of the statistical data corresponding to the each coordinate interval.
